(19) United States
(12) Patent Application Publication
(10) Pub. No.: US 2019/0059629 A1
(43) Pub. Date: Feb. 28, 2019

(54) Egg White Cooking Assembly

(71) Applicant: Chase Walton, West Palm Circle, FL (US)

(72) Inventor: Chase Walton, West Palm Circle, FL (US)

(21) Appl. No.: 15/690,357

(22) Filed: Aug. 30, 2017

(51) Int. Cl. A47J 29/00

(52) U.S. Cl. CPC A47J 29/00

(57) ABSTRACT

An egg white cooking assembly for forming cooked, egg-shaped, egg white includes a shell, a dispenser, and a plug. The shell defines an interior space and comprises a first section and a second section. The first section is selectively and sealably couplable to the second section. A penetration, which is threaded, is positioned through the shell. The dispenser has an outlet that is dimensionally smaller than the penetration. The dispenser is configured to position and to selectively dispense, through the penetration into the shell, at least one portion of albumen that is volumetrically equivalent to the interior space. The plug is threadedly couplable to the shell to sealably close the penetration. The shell is configured to be heated to cook the albumen to form a product that is shaped complementarily to the shell. The first section is positioned to be decoupled from the second section to free the product.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to cooking assemblies and more particularly pertains to a new cooking assembly for forming cooked, egg-shaped, egg white.

### BRIEF SUMMARY OF THE INVENTION

An embodiment of the disclosure meets the needs presented above by generally comprising a shell, a dispenser, and a plug. The shell defines an interior space and comprises a first section and a second section. The first section is selectively and sealably couplable to the second section. A penetration, which is threaded, is positioned through the shell. The dispenser has an outlet that is dimensionally smaller than the penetration. The dispenser is configured to position and to selectively dispense, through the penetration into the shell, at least one portion of albumen that is volumetrically equivalent to the interior space. The plug is threadedly couplable to the shell to sealably close the penetration. The shell is configured to be heated to cook the albumen to form a product that is shaped complementarily to the shell. The first section is positioned to be decoupled from the second section to free the product.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an egg white cooking assembly according to an embodiment of the disclosure.

FIG. 2 is a side view of an embodiment of the disclosure.

FIG. 3 is a bottom view of an embodiment of the disclosure.

FIG. 4 is a side view of an embodiment of the disclosure.

FIG. 5 is a cross-sectional view of an embodiment of the disclosure.

FIG. 6 is an exploded view of an embodiment of the disclosure.

### DETAILED DESCRIPTION OF THE INVENTION

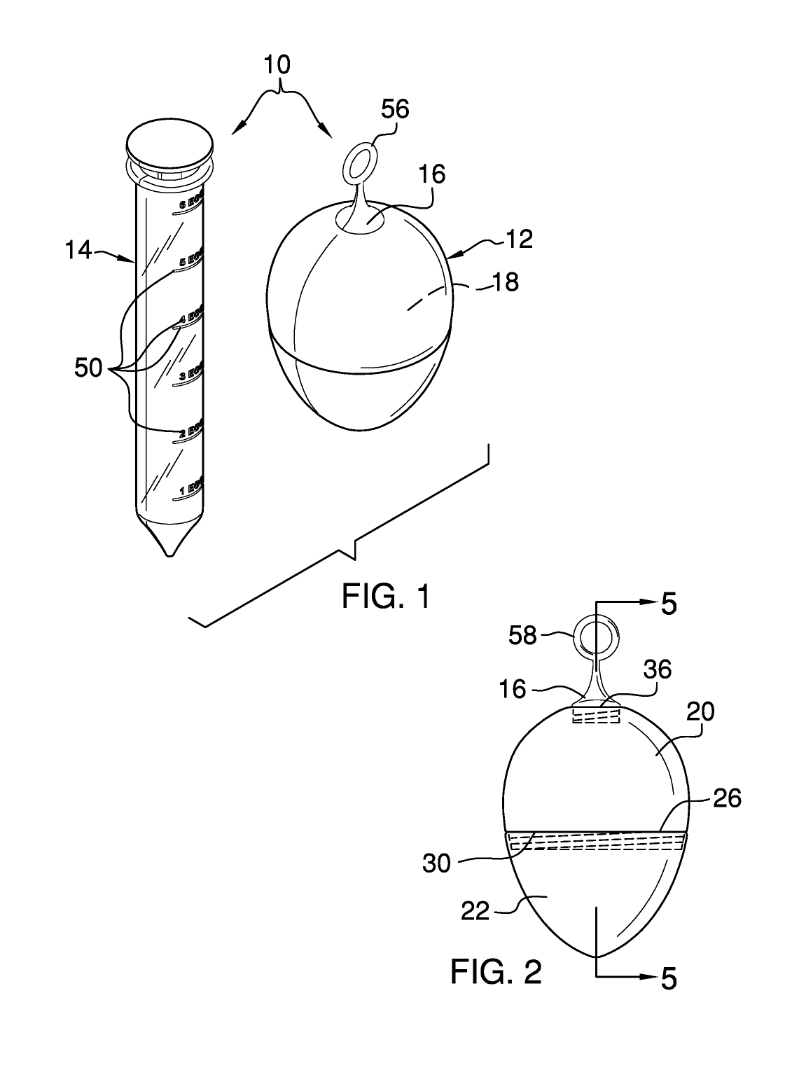

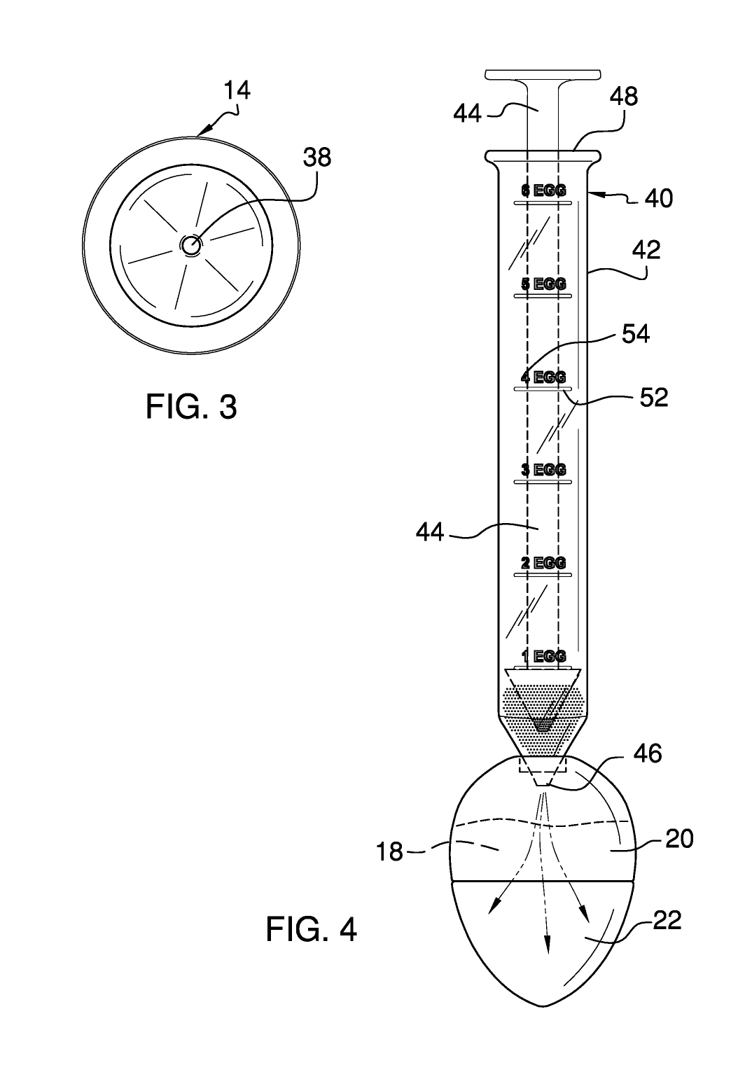

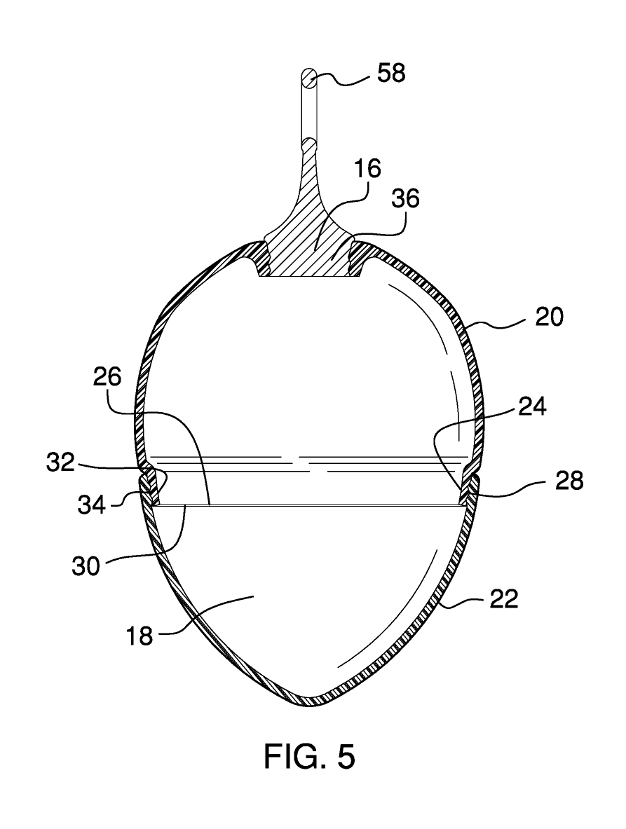

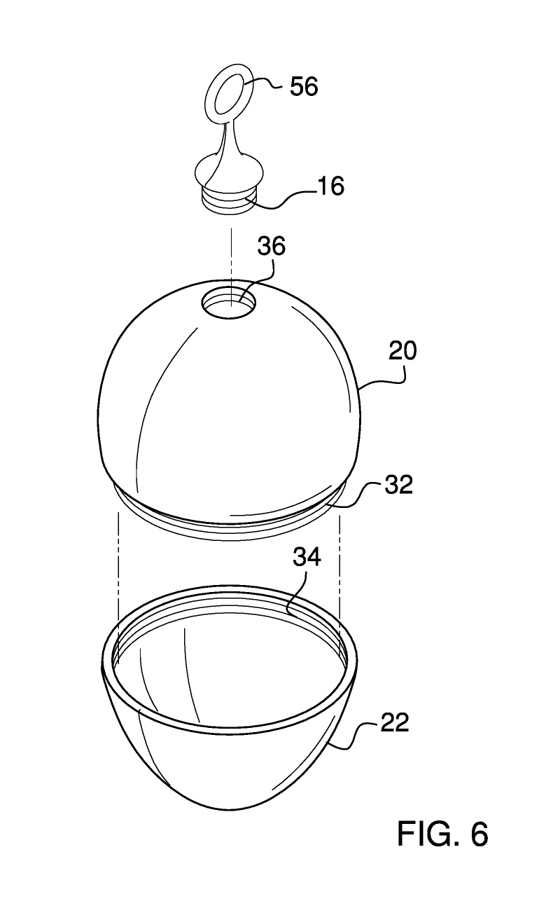

With reference now to the drawings, and in particular to FIGS. 1 through 6 thereof, a new cooking assembly embodying the principles and concepts of an embodiment of the disclosure and generally designated by the reference numeral 10 will be described.

As best illustrated in FIGS. 1 through 6, the egg white cooking assembly 10 generally comprises a shell 12, a dispenser 14, and a plug 16. The shell 12 defines an interior space 18. The shell 12 comprises a first section 20 and a second section 22. The first section 20 is selectively sealably couplable to the second section 22. In one embodiment, the shell 12 is egg shaped. In another embodiment, the interior space 18 is substantially volumetrically equivalent to two egg whites.

A first coupler 24 is coupled to a perimeter 26 of the first section 20. A second coupler 28 is coupled to a circumference 30 of the second section 22. The second coupler 28 is complementary to the first coupler 24. The second coupler 28 is positioned to selectively couple to the first coupler 24 to sealably couple the second section 22 to the first section 20. In one embodiment, the first coupler 24 comprises male threads 32 and the second coupler 28 comprises female threads 34.

A penetration 36 is positioned through the shell 12. The penetration 36 is threaded. In one embodiment, the penetration 36 is centrally positioned in the first section 20. The plug 16 is complementary to the penetration 36. The penetration 36 is positioned to selectively threadedly insert the plug 16 to sealably close the penetration 36.

The dispenser 14 has an outlet 38 that is dimensionally smaller than the penetration 36. The penetration 36 is positioned to insert the outlet 38 into the interior space 18. The dispenser 14 is configured to position, and to selectively dispense, at least one portion of albumen that is volumetrically equivalent to the interior space 18. The dispenser 14 is configured to inject the albumen through the penetration 36 into the shell 12 to fill the interior space 18.

The penetration 36 is positioned to selectively threadedly insert the plug 16 to sealably close the penetration 36 to retain the albumen in the interior space 18. The shell 12 is configured to be heated to cook the albumen and to form a product that is shaped complementarily to the shell 12. The first section 20 is positioned to decouple from the second section 22 to free the product from the shell 12.

In one embodiment, the dispenser 14 comprises a syringe 40. The syringe 40 comprises a barrel 42 and a plunger 44. In this embodiment, the outlet 38 comprises a tip 46 of the barrel 42. The plunger 44 is slidably and sealably positionable between the tip 46 and a top 48 of the barrel 42. The plunger 44 is configured to draw the albumen through the tip 46 as the plunger 44 is motivated distally from the tip 46. The plunger 44 is configured to inject the albumen through the tip 46 into the interior space 18 as the plunger 44 is motivated toward the tip 46.

Indicia 50 are positioned on the barrel 42. The indicia 50 extend from the tip 46 to proximate to the top 48 of the barrel 42. Each indicium 50 is configured to indicate the quantity of egg whites that is positioned in, and dispensed from, the barrel 42. In one embodiment, each indicium 50 comprises a bar 52 and a number 54. The number 54 corresponds to the quantity of egg whites that is positioned in the barrel 42 when the barrel 42 is filled to the bar 52.

A handle 56 is coupled to and extends from the plug 16. The handle 56 is configured to position between digits of a hand of a user to rotate the plug 16 relative to the shell 12 to selectively couple the plug 16 to the shell 12. The plug 16 sealably closes the penetration 36 to retain the albumen in the interior space 18. In one embodiment, the handle 56 comprises a ring 58.

In use, the female threads 34 that are positioned on the second section 22 are positioned to couple to the male threads 32 to sealably couple the second section 22 to the first section 20. The plunger 44 is configured to draw the albumen through the tip 46 as the plunger 44 is motivated distally from the tip 46. The plunger 44 also is configured to inject the albumen through the tip 46 and the penetration 36 into the interior space 18 as the plunger 44 is motivated toward the tip 46. Each indicium 50 is configured to indicate the quantity of egg whites that is positioned in, and dispensed from, the barrel 42. The handle 56 is configured to position between the digits of the hand of the user to rotate the plug 16 relative to the first section 20 to selectively couple the plug 16 to the shell 12. The plug 16 sealably closes the penetration 36 to retain the albumen in the interior space 18. The shell 12 is configured to be heated to cook the albumen and to form the product that is shaped complementarily to the shell 12. The female threads 34 are positioned to decouple from the male threads 32 to decouple the second section 22 from the first section 20 to free the product from the shell 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An egg white cooking assembly comprising:
a shell defining an interior space, said shell comprising a first section and a second section, said first section being selectively and sealably couplable to said second section;
a penetration positioned through said shell, said penetration being threaded;
a dispenser having an outlet, said outlet being dimensionally smaller than said penetration such that said penetration is positioned for inserting said outlet into said interior space, said dispenser being configured for positioning and for selectively dispensing at least one portion of albumen volumetrically equivalent to said interior space;
a plug complementary to said penetration, said plug being selectively threadedly couplable to said shell for sealably closing said penetration; and
wherein said outlet is positioned on said dispenser such that said dispenser is configured for injecting the albumen through said penetration into said shell for filling said interior space, wherein said penetration is positioned in said shell such that said penetration is positioned for selectively threadedly inserting said plug for sealably closing said penetration for retaining the albumen in said interior space, such that shell is configured for heating for cooking the albumen and for forming a product shaped complementarily to said shell, wherein said first section is positioned for decoupling from said second section for freeing the product from said shell.

2. The assembly of claim 1, further including said shell being egg shaped.

3. The assembly of claim 1, further including said interior space being substantially volumetrically equivalent to two egg whites.

4. The assembly of claim 1, further comprising:
a first coupler coupled to a perimeter of said first section;
a second coupler coupled to a circumference of said second section, said second coupler being complementary to said first coupler; and
wherein said second coupler is positioned on said second section such that said second coupler is positioned for selectively coupling to said first coupler for sealably coupling said second section to said first section.

5. The assembly of claim 4, further including said first coupler comprising male threads, said second coupler comprising female threads.

6. The assembly of claim 1, further including said penetration being centrally positioned in said first section.

7. The assembly of claim 1, further including said dispenser comprising a syringe, said syringe comprising a barrel and a plunger, said outlet comprising a tip of said barrel, said plunger being slidably and sealably positionable between said tip and a top of said barrel, wherein said plunger is positioned in said barrel such that said plunger is configured for drawing the albumen through said tip as said plunger is motivated distally from said tip, and wherein said plunger is configured for injecting the albumen through said tip into said interior space as said plunger is motivated toward said tip.

8. The assembly of claim 7, further including indicia positioned on said barrel, said indicia extending from said tip to proximate to said top of said barrel, each said indicium indicating a quantity of egg whites positioned in said barrel, wherein said indicia are positioned on said barrel such that each said indicium is configured for indicating the quantity of egg whites positioned in and dispensed from said barrel.

9. The assembly of claim 8, further including each said indicium comprising a bar and a number, said number corresponding to the quantity of egg whites positioned in said barrel when said barrel is filled to said bar;

10. The assembly of claim 1, further including a handle coupled to and extending from said plug, wherein said handle is positioned on said plug such that said handle is configured for positioning between digits of a hand of a user for rotating said plug relative to said first section for selectively coupling said plug to said shell for sealably closing said penetration for retaining the albumen in said interior space.

11. The assembly of claim 10, further including said handle comprising a ring.

12. An egg white cooking assembly comprising:
a shell defining an interior space, said shell comprising a first section and a second section, said first section being selectively sealably couplable to said second section, said shell being egg shaped, said interior space being substantially volumetrically equivalent to two egg whites;
a first coupler coupled to a perimeter of said first section, said first coupler comprising male threads;
a second coupler coupled to a circumference of said second section, said second coupler being complementary to said first coupler, wherein said second coupler is positioned on said second section such that said second coupler is positioned for selectively coupling to said first coupler for sealably coupling said second section to said first section, said second coupler comprising female threads;
a penetration positioned through said shell, said penetration being threaded, said penetration being centrally positioned in said first section;
a plug complementary to said penetration, said plug being selectively threadedly couplable to said shell for sealably closing said penetration, wherein said penetration is positioned in said first section such that said penetration is positioned for selectively threadedly inserting said plug for sealably closing said penetration;
a dispenser having an outlet, said outlet being dimensionally smaller than said penetration such that said penetration is positioned for inserting said outlet into said interior space, said dispenser being configured for positioning and for selectively dispensing at least one portion of albumen volumetrically equivalent to said interior space, wherein said outlet is positioned on said dispenser such that said dispenser is configured for injecting the albumen through said penetration into said shell for filling said interior space, wherein said penetration is positioned in said shell such that said penetration is positioned for selectively threadedly inserting said plug for sealably closing said penetration for retaining the albumen in said interior space, such that shell is configured for heating for cooking the albumen and for forming a product shaped complementarily to said shell, wherein said first section is positioned for decoupling from said second section for freeing the product from said shell, said dispenser comprising a syringe, said syringe comprising a barrel and a plunger, said outlet comprising a tip of said barrel, said plunger being slidably and sealably positionable between said tip and a top of said barrel, wherein said plunger is positioned in said barrel such that said plunger is configured for drawing the albumen through said tip as said plunger is motivated distally from said tip, and wherein said plunger is configured for injecting the albumen through said tip into said interior space as said plunger is motivated toward said tip;
indicia positioned on said barrel, said indicia extending from said tip to proximate to said top of said barrel, each said indicium indicating a quantity of egg whites positioned in said barrel, wherein said indicia are positioned on said barrel such that each said indicium is configured for indicating the quantity of egg whites positioned in and dispensed from said barrel, each said indicium comprising a bar and a number, said number corresponding to the quantity of egg whites positioned in said barrel when said barrel is filled to said bar;
a handle coupled to and extending from said plug, wherein said handle is positioned on said plug such that said handle is configured for positioning between digits of a hand of a user for rotating said plug relative to said first section for selectively coupling said plug to said shell for sealably closing said penetration for retaining the albumen in said interior space, said handle comprising a ring; and
wherein said female threads are positioned on said second section such that said female threads are positioned for coupling to said male threads for sealably coupling said second section to said first section, wherein said plunger is positioned in said barrel such that said plunger is configured for drawing the albumen through said tip as said plunger is motivated distally from said tip, wherein said plunger is configured for injecting the albumen through said tip and said penetration into said interior space as said plunger is motivated toward said tip, wherein said indicia are positioned on said barrel such that each said indicium is configured for indicating the quantity of egg whites positioned in and dispensed from said barrel, wherein said handle is positioned on said plug such that said handle is configured for positioning between the digits of the hand of the user for rotating said plug relative to said first section for selectively coupling said plug to said shell for sealably closing said penetration for retaining the albumen in said interior space, such that shell is configured for heating for cooking the albumen and for forming the product shaped complementarily to said shell, wherein said female threads are positioned for decoupling from said male threads for decoupling said second section from said first section for freeing the product from said shell.
